(19) United States
(12) Patent Application Publication
(10) Pub. No.: US 2002/0066656 A1
(43) Pub. Date: Jun. 6, 2002

(54) Electric shock-proof security device of a receptacle

(76) Inventor: Hung-Chiang Shao, Pan Chiao City (TW)

Correspondence Address: VARNDELL & VARNDELL, PLLC, 106-A South Columbus Street, ALEXANDRIA, VA, 22314, US

(21) Appl. No.: 09/729,314

(22) Filed: Dec. 5, 2000

(51) Int. Cl. H01R 13/70

(52) U.S. Cl. 200/51 R

(57) ABSTRACT

An electric shock-proof security device of a receptacle is disclosed, especially as an undesired substance is inserted into the receptacle, the electric shock-proof security device serves to prevent to get an electric shock. The device comprises a cover, two stoppers, elastomers and a supporting seat. Two stoppers include a right stopper and a left stopper. The right stopper is an integral formed stepped piece; and a concave tilt surface is formed at a front edge of a higher step and a through hole is formed at a selected surface of a lower step. The left stopper is integrally formed as a frame and has a front strip and rear strip. An outer side of the front strip has a concave tilt surface. The rear strip is formed as a lower recess. Thus, Thereby, the high step portion of the right stopper passes through the left stopper and is overlapped upon the rear strips of the left stopper. Then, the two stoppers are placed on the supporting seat. Within the supporting seat, two elastomers resist against the right stopper and left stopper. Therefore, an electric shock-proof security device of a receptacle is formed. The two stoppers serve to isolate the undesired substance so as no to be in contact with the conductive piece and the danger of electric shock is prevented.

### FIELD OF THE INVENTION

The present invention relates to an electric shock-proof security device of a receptacle, wherein a right stopper and a left stopper are installed in a cover. Two pins of a plug must be inserted into the inserting holes of the receptacle, then the stoppers will move away so that the pins can pass through the inserting holes to the conductive pieces for electric conduction. If only one undesired substance is inserted thereinto, it will be hindered by the stoppers so as to prevent to get an electric shock.

### BACKGROUND OF THE INVENTION

In the prior art receptacle, the conductive pieces are exactly adjacent to the inserting holes. As the pins of the plug are inserted, then it can be in contact with the conductive piece. Although this structure has the effect of isolation, no stoppers between the conductive pieces and the pins so that it is possible to generate some dangerous condition. If a child inserts an undesired substance into the inserting hole, the child possibly get an electric shock. Especially, the movable receptacle at a distal of an extending wire is often placed on the ground and thus, it is easy taken by a child and as a result, the aforesaid condition easily occurs.

Therefore, some prior art designs about electric shock-proof device of a receptacle are disclosed, as those disclosed in U.S. Pat. Nos. 4,867,694, 5,281,156, 6,086,391 so as to acquire the effect of electric shock-proof. However, in these applications, the structures of the stoppers are too complex, moreover, a helical type compressible spring is used. The space in the receptacle is finite, so that as the spring is elastically fatigue, the effect is not good, especially, as the stoppers restore to the original places. Furthermore, to place the spring in the receptacle is a hard work.

### SUMMARY OF THE INVENTION

Accordingly, the primary object of the present invention is to provide an electric shock-proof security device of a receptacle, wherein below the receptacle, two right stoppers moving along opposed directions are arranged. The rear ends of the two stoppers are installed with elastomers, respectively, so that as the stoppers moving from a normal position can restore to the original position. Therefore, as the user desires to insert a plug, the two pins of the plug must be inserted the stoppers to move away. Then the pins can be in contact with the conductive piece. Therefore, if only one undesired substance is inserted into on inserting hole, since the moving length of the stoppers are not enough, the undesired substance will be hindered so as to prevent the conductive piece from being touched by a mistake, especially, induced from a child.

The various objects and advantages of the present invention will be more readily understood from the following detailed description when read in conjunction with the appended drawing.

### BRIEF DESCRIPTION OF THE DRAWINGS

FIG. 1 is an exploded perspective view of the electric shock-proof security device of a receptacle of the present invention.

FIG. 2 is an assembled perspective view of the electric shock-proof security device of a receptacle according to the present invention.

FIG. 3 is an upper view showing an assembled condition of the present invention.

FIG. 4 is a cross sectional view of the present invention.

FIG. 5 is a schematic view showing the use of the present invention.

FIG. 6 is a schematic view showing the present invention from preventing an undesired substance from being inserted into the receptacle.

FIG. 7 is another schematic view showing the present invention from preventing an undesired substance from being inserted into the receptacle.

### DETAILED DESCRIPTION OF THE PREFERRED EMBODIMENTS

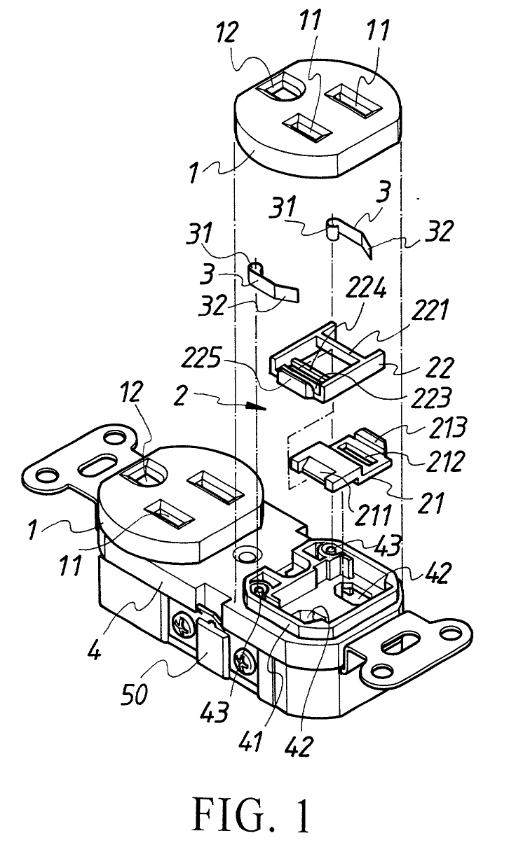

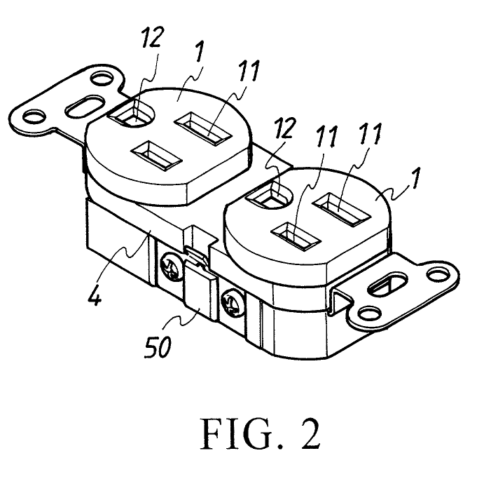

Referring to FIGS. 1 and 2. The electric shock-proof security device of a receptacle of the present invention is illustrated. The electric shock-proof security device of the present invention includes a cover 1, two stoppers 2, elastomers 3, a supporting seat 4 and other components.

The cover 1 has a function of guiding pines for electrical connection. The shape thereof is according to the supporting seat 4 therebelow. The surface of the cover 1 is installed with inserting holes 11 for positive and negative electrodes.

Two stoppers 2 include a right stopper 21 and a left stopper 22. The right stopper 21 is an integral formed stepped piece; and a concave tilt surface 211 is formed at a front edge of a higher step and a rectangular through hole 212 is formed at a selected surface of a lower step. A block 213 is installed at a rear edge of a lower step. Furthermore, the left stopper 22 is integrally formed as a frame and has a front strip 221 and rear strip 223. An outer side of the front strip 221 has a concave tilt surface 222. The rear strip 223 is formed as a lower recess. A further strip 224 is formed at an inner side thereof and a block 225 is formed at a rear side thereof.

Each elastomer 3 is formed by folding a long metal piece so that if the left and right stoppers 21, 22 are pushed, they can restore to the original place. The rear end of the elastomer is bent to be formed as a round cylinder 31 and the front section is bent as a tilt elastic hook 32.

The supporting seat 4 covers an insulating seat on an upper end of a prior art receptacle 50 so that the conductive piece is positioned on an insulating seat therebelow and has a slight [symbol] shape. The shape of the supporting seat 4 can be varied according to the receptacle. A frame 41 is formed at a selecting portion on the surface thereof. Two through holes 42 with respect to the conductive pieces are installed at a bottom of the inner portion of the frame 41. Two sides of the interior of the frame 41 are installed with post 43 for being engaged by the elastomers 3.

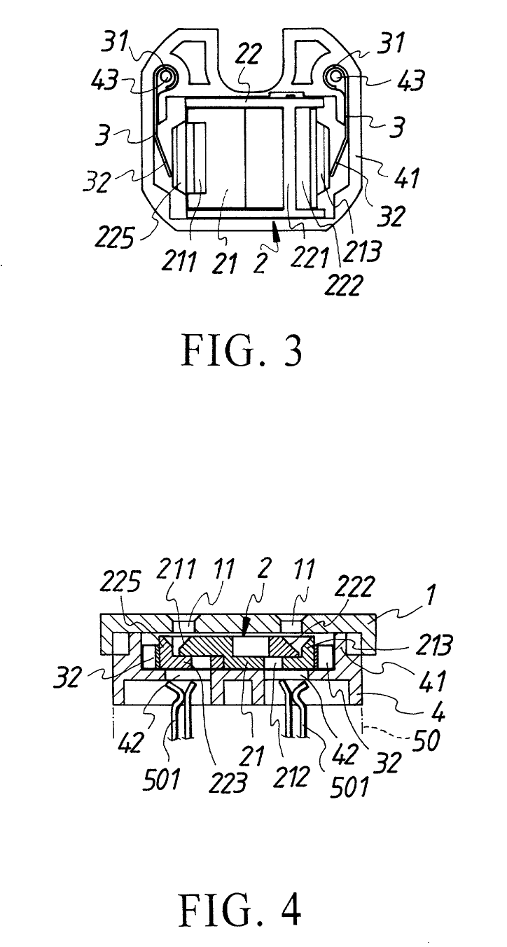

Thereby, the high step portion of the right stopper 21 passes through the left stopper 22 and is overlapped with the rear strips 223 and 224 of the left stopper 22 so that the right stopper 21 seals the hollow portion of the left stopper 22 and the through hole 212 of the right stopper 22 are covered by the front strip of the left stopper 21. Thus, the left stopper 22 and right stopper 21 are slid with respect to one another. The right stopper 21 and left stopper 22 are installed in the frame 41 of the supporting seat 4 so as to exactly cover the through hole 42 on the bottom of the frame 41 (referring to FIG. 3). The two posts 43 in the frame 41 of the supporting seat 4 are received by the round cylinders 31 of the elastomers 3 so that the front elastic hooks 32 at the front end extends to the two sides of the interior of the frame 41, and thus they resists against the blocks 213, 225 at the rear sides of the right stopper 21 and left stopper 22. By this elasticity, the right stopper 21 and left stopper 22 are sealed in normal (referring to FIG. 4). The cover 1 covers on the frame 41 of the supporting seat 4 for guiding receptacle to insert therein. Therefore, the electric shock-proof security device of a receptacle of the present invention is formed.

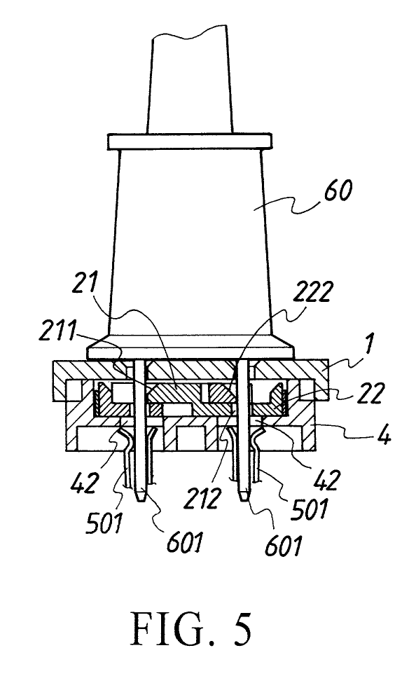

In the present invention, in order to prevent that some undesired substances are inserted into the receptacle by carelessness so as to get an electric shock. Referring to FIG. 5, in normal condition, when two pins 601 of a normal plug 60 are inserted into the inserting holes 11 of the cover 1 at the same time, they resists against the tilt surfaces 211, 222 of the right stopper 21 and left stopper 22 so that the right stopper 21 and left stopper 22 are pushed inwards. Thus, a hollow portion of the left stopper 22 and the through hole 212 of the right stopper 21 are left for being passed by pins 601 and then the pins passes through the through holes 41 of the supporting seat 4 to be in contact with the conductive piece 501. In the present invention, in a normal condition, the user's hand holes the receptacle 60, and thus no danger occurs. When the receptacle 60 is pulled out, the left stopper 22 and right stopper 21 resists against the elastomer 3 so as to restore to the original place.

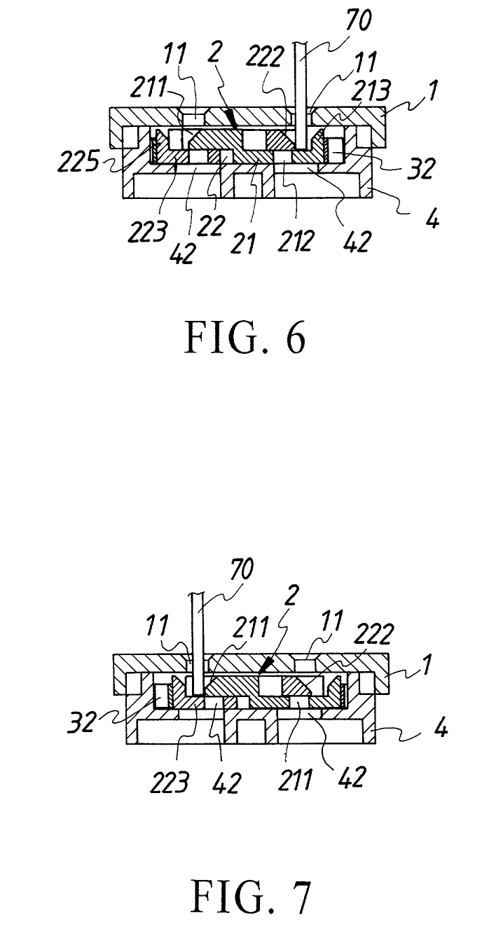

When in abnormal condition, the right stopper 21 and left stopper 22 serves to resist against undesired substances 70, such as steel wires or bolt, etc., as shown in FIGS. 6 and 7. In detail, if one undesired substance is inserted into the inserting hole 11 of the cover 1 so as to push the left stopper 22, the left stopper 22 will move upwards due to the tilt surface 222. The undesired substance 70 will insert thereinto slightly. Since the right stopper 21 is not pushed at the same time, it is resisted by the lower stepped portion, and can not pass through the through hole 212. On the contrary, if the undesired substance 70 is inserted from another end, since the left stopper 22 does not be pushed as the same time, that is, it is hindered by the strip 223 at the rear side, thus, the undesired substance 70 can not further inserted into the receptacle 50 to be in contact with the conductive piece 501. Therefore, no matter which hole inserted by the undesired substance, no current conducts. Consequently, the abnormal using of a receptacle, such as insertion of an undesired substance, will not induce a danger of electric shock.

Therefore, the present invention has substantially the effect of electric shock-proof as an abnormal use. Since two stoppers are installed below the cover 1, dusts or other impurities can not move to the conductive piece 501 so that the conductivity is sustained. However, the embodiment of the present invention is confined to the aforesaid receptacle 50. Any movable receptacle of an extending wire can be used in the present invention so as to get an effect of electric shock-proof.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electric shock-proof security device of a receptacle comprising a cover, two stoppers, elastomers and a supporting seat; wherein
the cover has a function of guiding pines for electrical connection; a shape thereof is according to the supporting seat therebelow; a surface of the cover is installed with inserting holes 11 for positive and negative electrodes.
two stoppers include a right stopper and a left stopper; the right stopper is an integral formed stepped piece; and a concave tilt surface is formed at a front edge of a higher step and a rectangular through hole is formed at a selected surface of a lower step; a block is installed at a rear edge of a lower step; furthermore, the left stopper is integrally formed as a frame and has a front strip and a rear strip; an outer side of the front strip has a concave tilt surface; the rear strip is formed as a lower recess; a further strip is formed at an inner side thereof and a block is formed at a rear side thereof;
each elastomer is formed by folding a long metal piece; a rear end of the elastomer is bent to be formed as a round cylinder and the front section is bent as a tilt elastic hook; and
the supporting seat covers on an insulating seat at an upper end of a receptacle; a shape of the supporting seat is varied according to the receptacle; a frame 41 formed at a selecting portion on the surface thereof; two through holes with respect to the conductive pieces are installed at a bottom of an inner portion of the frame; two sides of an interior of the frame are installed with post for being engaged by the elastomers;
thereby, the high step portion of the right stopper passes through the left stopper and is overlapped upon the rear strips of the left stopper so that the right stopper seals the hollow portion of the left stopper and the through hole of the right stopper are covered by the front strip of the left stopper so that the left stopper and right stopper are slid with respect to one another; the right stopper and left stopper are installed in the frame 41 of the supporting seat 4 so as to exactly cover the through hole on the bottom of the frame; the two posts in the frame of the supporting seat are received by the round cylinders of the elastomers so that the front elastic hooks at the front end extends to the two sides of the interior of the frame, and thus they resist against the blocks at the rear sides of the right stopper and left stopper; the cover covers on the frame of the supporting seat for guiding a receptacle to be inserted therein; therefore, the electric shock-proof security device of a receptacle is formed; as an undesired substance is inserted from one end of the through hole, the two stoppers serve to isolate the undesired substance so as no to be in contact with the conductive piece and the danger of electric shock is prevented.

2. The electric shock-proof security device of a receptacle as claimed in claim 1, wherein a surface of the cover is formed with a grounding inserting hole for matching to inserting holes of positive and negative electrodes.
